(19) United States
(12) Patent Application Publication
(10) Pub. No.: US 2013/0262679 A1
(43) Pub. Date: Oct. 3, 2013

(54) Dataset Processing Using Network Performance Information

(71) Applicants: Wael William Diab, San Francisco, CA (US); Nicholas Ilyadis, Merrimack, NH (US)

(72) Inventors: Wael William Diab, San Francisco, CA (US); Nicholas Ilyadis, Merrimack, NH (US)

(73) Assignee: Broadcom Corporation, Irvine, CA (US)

(21) Appl. No.: 13/432,643

(22) Filed: Mar. 28, 2012

(51) Int. Cl. G06F 15/173

(52) U.S. Cl. 709/226

(57) ABSTRACT

Dataset processing based on network performance information. Processing of large datasets can be based on particular network computing resources that are selected based on network performance information (e.g., link speed, latency, energy efficiency, etc.) associated with the network computing resources. With the network performance information, a network topology of the computing resources can be created that considers not only the processing capabilities of the network computing resources but also the performance of the network that interconnects the computing devices.

### BACKGROUND

1. Field of the Invention

The present invention relates generally to network computing and, more particularly, to dataset processing based on network performance information.

2. Introduction

Processing capabilities of computing devices continue to increase as new generations of computing hardware dwarf the capabilities of previous generations. Local area networks and wide area networks can interconnect such computing devices in a way that enables presentation of such devices as network computing resources that can be leveraged by other devices and applications.

An increasing number of applications are able to make collective use of these network computing resources in addressing large scale computing efforts such as scientific and engineering simulations. The collective capacity of such network computing resources enables processing of large datasets.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of a network of computing resources.

FIG. 2 illustrates an example of an energy efficiency control policy implemented in a network computing resource.

FIG. 3 illustrates an example of energy efficiency control customization in a network link.

FIG. 4 illustrates an example of dataset processing based on energy efficiency in a network.

FIGS. 5 and 6 illustrate flowcharts of processes of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Processing of large datasets is made possible through the leveraging of computing devices that are interconnected through local area networks and wide area networks. In this distributed computing framework, the particular network computing resources that are to be used in the processing of the large datasets can be selected based on network performance information (e.g., link speed, latency, energy efficiency, etc.) associated with the network computing resources. With the network performance information, a network topology of the computing resources can be created that considers not only the processing capabilities of the network computing resources but also the performance of the network that interconnects the computing devices. The network performance information can therefore be used in determining the particular network computing resources that are selected for processing of a particular dataset.

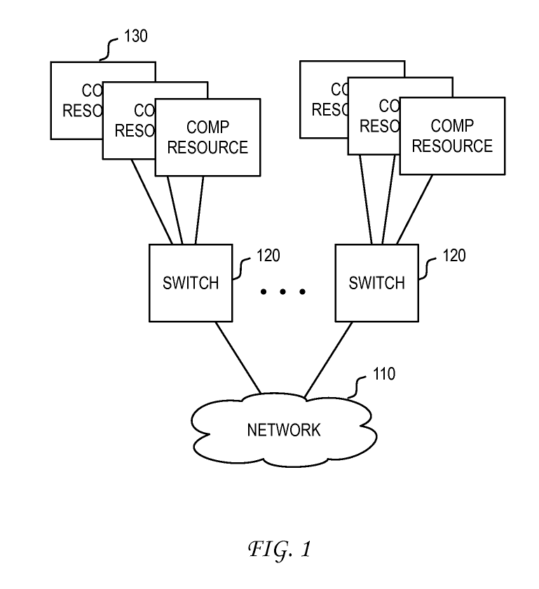

FIG. 1 illustrates an example of a network of computing devices. As illustrated a plurality of computing resources 130 are interconnected using one or more switches 120 that are coupled to network 110. Network 110 can include a variety of electronic networks such as the Internet or a mobile network. As such, network 110 can include one or more of a local area network, medium area network, or wide-area network. In one embodiment, switch 120 is a networking bridge device with data ports that can additionally have routing/switching capability, e.g., L3 switch/router. Switch 120 can have as little as two data ports or as many as 400 or more data ports, and can direct traffic in full duplex from any port to any other port, effectively making any port act as an input and any port as an output.

As would be appreciated, computing resource 130 can represent any computing device that can be leveraged in a distributed computing environment. While the particular processing power of the computing device is a factor in its suitability for use in processing a large dataset, the significance of the level of processing power begins to diminish as the breadth of the distributed computing model widens in scope. In other words, if the distributed computing model can scale to thousands of devices, the particular processing power of one of those devices begins to diminish in significance.

Another key factor in the suitability of use of a computing device is the performance of the network used to connect the computing device to the distributed computing framework. To illustrate this factor, consider a computing device that does not have full-time connectivity to the network. This computing device can be designed to receive a job request from a scheduler when it is connected to the network, perform the processing of the job request while disconnected to the network, then report the results of the processing when it is reconnected to the network. This network performance can be a factor especially when considering the relative suitability of another computing device that has full-time visibility to the network. As this example illustrates, the performance of the network that connects the computing devices into the distributed computing framework can be a significant factor in the usability of a computing device for the processing of a particular dataset.

As would be appreciated, various other network performance criteria can also play a large role in determining the relative suitability of a computing device for the processing of a dataset. For example, network performance criteria such as a speed of a network link, network latency, startup processing time (e.g., processor or other sub-system sleep states), energy efficiency modes supported, energy efficiency mode transition times (e.g., quick wake, regular wake, etc.) that can be based on the number of sub-systems turned off, the type of energy saving mode that it is in, etc., or any other metric that can provide a context for the processing capability of the computing device can be used in determining the relative suitability of a computing device to operate as a network computing resource.

The principles of the present invention are not dependent on a particular type of computing resource 130. As such, a computing resource can represent a computing device with various computer system configurations, including multi-core multiprocessor systems, minicomputers, mainframe computers, computer linked or clustered with distributed functions, pervasive or miniature computers that may be embedded into virtually any device, as well as distributed computing over the web. In the latter case, in addition to WAN latency there can also be latency within each domain (e.g., within a home for energy efficient Ethernet). Distributed computing protocols would typically take into account latency for the job assigned to a particular domain but not latency within the domain itself. In one embodiment, a computing resource of larger capacity/performance can be a computer server.

To illustrate the features of the present invention, an example of network performance criteria related to energy efficiency is now provided. This example is not intended to be limiting, but is provided to demonstrate the usage of network performance information in a distributed computing framework.

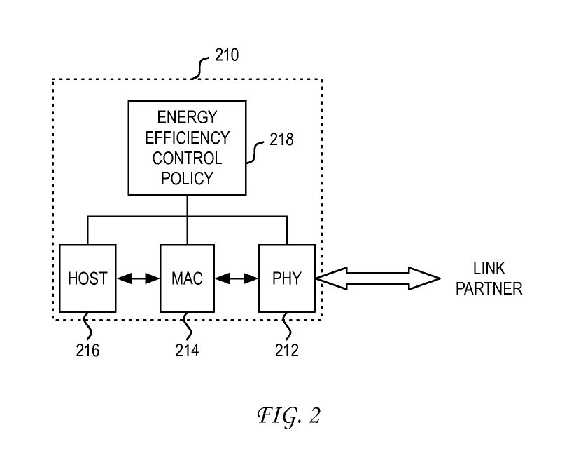

FIG. 2 illustrates an example of an energy efficiency control policy implemented in a network computing device. In general, energy efficient networks often attempt to save power when the traffic utilization of a network link is at a low level. This serves to minimize the performance impact while maximizing power savings. At a broad level, the energy efficiency control policy for a particular link in the network determines when to enter an energy saving state, what energy saving state (e.g., level of energy savings) to enter, how long to remain in that energy saving state, what energy saving state to transition to out of the previous energy saving state, the transition times from an energy saving state (e.g., quick wake, regular wake, etc) and any other action that impacts energy efficiency. In one example, the energy efficiency control policy can base these decisions on a combination of static settings established by an IT manager and the properties of the traffic on the link itself.

FIG. 2 illustrates an example of a network computing device to which an energy efficiency control policy can be applied. As illustrated in FIG. 2, network device 210 includes physical layer device (PHY) 212, media access control (MAC) 214, and host 216. In general, host 216 can comprise suitable logic, circuitry, and/or code that may enable operability and/or functionality of the five highest functional layers for data packets that are to be transmitted over the link. Since each layer in the OSI model provides a service to the immediately higher interfacing layer, MAC controller 214 can provide the necessary services to host 216 to ensure that packets are suitably formatted and communicated to PHY 212. MAC controller 214 can comprise suitable logic, circuitry, and/or code that may enable handling of data link layer (Layer 2) operability and/or functionality. MAC controller 214 can be configured to implement Ethernet protocols, such as those based on the IEEE 802.3 standard, for example. PHY 212 can be configured to handle physical layer requirements, which include, but are not limited to, packetization, data transfer and serialization/deserialization (SERDES).

In general, controlling the data rate of the link may enable the network computing device and possibly its link partner to communicate in a more energy efficient manner. More specifically, a reduction in link rate to a sub-rate of the main rate enables a reduction in power, thereby leading to power savings. In one example, this sub-rate can be a zero rate, which produces maximum power savings.

One example of subrating is through the use of a subset PHY technique. In this subset PHY technique, a low link utilization period can be accommodated by transitioning the PHY to a lower link rate that is enabled by a subset of the parent PHY. In one embodiment, the subset PHY technique is enabled by turning off portions of the parent PHY to enable operation at a lower or subset rate (e.g., turning off three of four channels). In another embodiment, the subset PHY technique can be enabled by slowing down the clock rate of a parent PHY. For example, a parent PHY having an enhanced core that can be slowed down and sped up by a frequency multiple can be slowed down by a factor of 10 during low link utilization, then sped up by a factor of 10 when a burst of data is received. In this example of a factor of 10, a 10G enhanced core can be transitioned down to a 1G link rate when idle, and sped back up to a 10G link rate when data is to be transmitted.

Another example of subrating is through the use of a low power idle (LPI) technique. In general, LPI relies on the PHY entering a quiet state where power savings can be achieved when there is nothing to transmit. Power is thereby saved when the link is off. Refresh signals can be sent periodically to enable wake up from the sleep mode.

In general, both the subset and LPI techniques involve turning off or otherwise modifying portions of the PHY during a period of low link utilization. As in the PHY, power savings in the higher layers (e.g., MAC) can also be achieved by using various forms of subrating as well. In general, a particular device can be designed to support multiple energy saving states that can have different numbers of sub-systems turned off and/or different amounts of associated wake-up time.

As FIG. 2 illustrates, network device 210 also includes energy efficiency control policy entity 218. In general, energy efficiency control policy entity 218 can be designed to determine when to enter an energy saving state, what energy saving state (i.e., level of energy savings) to enter, how long to remain in that energy saving state, what energy saving state to transition to out of the previous energy saving state, etc.

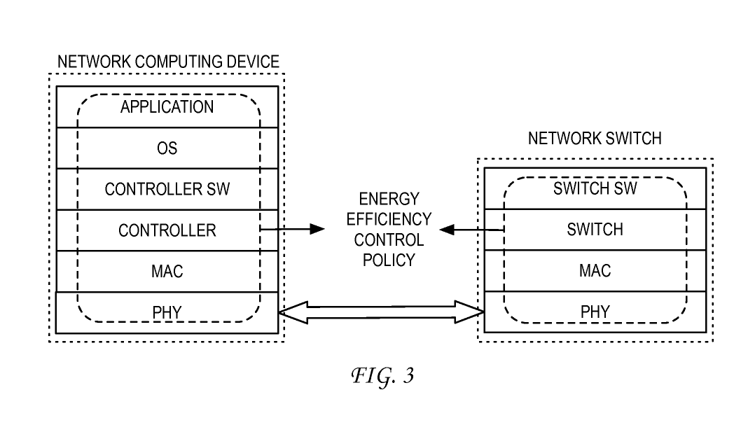

Energy efficiency control policy entity 218 in network device 110 includes software code that can interoperate with various layers, including portions of the PHY, MAC, switch, or other subsystems in the host. Energy efficiency control policy entity 218 can be enabled to analyze traffic on the physical link and to analyze operations and/or processing of data in itself or in its link partner. In this manner, energy efficiency control policy entity 218 can exchange information from, or pertaining to, one or more layers of the OSI hierarchy in order to establish and/or implement the energy efficiency control policy. FIG. 3 illustrates an example of an energy efficiency control policy, which can touch various layers on both ends (e.g., network computing device and network switch) of the link. In one embodiment, network management software such as that exemplified by Simple Network Management Protocol (SNMP) can be sued to configure devices and/or the energy efficiency control policy.

In producing energy savings, an energy efficiency control policy can effect intelligent decision making based on energy efficiency control policy settings, parameters and configurations that are established by a user (e.g., system administrator). For example, the user can establish empty or non-empty conditions of ports, queues, buffers, etc. to determine whether to transition to or from an energy saving state. The user can also establish various timers that can govern the determination of when to transition between various defined energy saving states. As would be appreciated, the energy efficiency control policy is dependent on the configuration of the energy efficiency control policy to a particular network device and traffic profile.

The energy efficiency capabilities of a network computing device represent a network performance criteria that can be used to assess the suitability of the network computing device as a network computing resource in a distributed computing framework. For example, assume that the network computing device has a 10G PHY that supports a LPI mode. This LPI mode has the capability of providing significant energy savings on the link that couples the network computing device to the network.

As noted, the energy efficiency control policy can control the entry/exit of the PHY to/from the LPI mode. Such decision making can be dependent on the utilization level of the link. For example, if no traffic is transmitted on the link for “long” periods of time in between bursts of traffic, then the energy efficiency control policy can leverage the LPI mode in producing energy savings.

This is in contrast to other traffic profiles that include, for example, the continued, intermittent transmission of low-bandwidth message traffic. In this scenario, the energy efficiency control policy could be precluded from instructing the PHY to enter the LPI mode. This can result due to an energy efficiency control policy that is designed to limit the impact on latency due to the continual entry/exit from the LPI mode due to consistent activity on the network link.

In recognizing the performance of the network associated with a network computing device, a scheduler for the jobs associated with the processing of a dataset could adjust to such network performance factors. For example, if jobs in the processing of the dataset can be batched together, then the usage of a network computing device having LPI functionality would be more attractive. The scheduler could then choose to select network computing devices that include LPI energy savings features for processing of the dataset.

As would be appreciated, the analysis of network performance information in addition to processing power enables effective tradeoffs in cost/performance in the processing of datasets. Any network performance criteria can be analyzed to determine which of a set of available network computing resources should be used for a particular dataset processing.

Where data transfer performance is paramount, then network link speeds can be a key factor. Where time-sensitive performance and/or data performance is paramount, then network latency due to sleep states can be a key factor. Where energy efficiency performance is paramount, then energy saving capabilities can be a key factor.

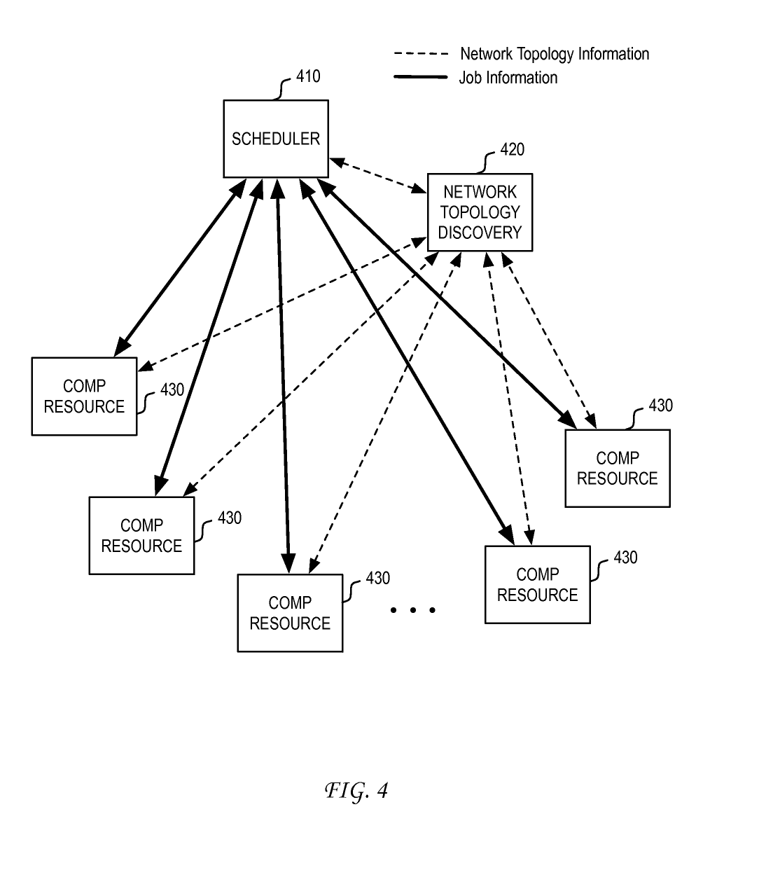

The availability of network performance information plays a significant role in the processing of large datasets. FIG. 4 illustrates an example of leveraging such network performance information. As illustrated, network computing resources 430 are designed to interface with network topology discovery system 420. As would be appreciated, this interface can be represented by a variety of mechanisms. In one example, network topology discovery system 420 is a workstation that is designed to discover or otherwise retrieve network topology information from network computing resources 430. Any of a variety of protocols (e.g., L2/L3 protocols) can be used alone or in combination to acquire network topology information. This process can be a fully automated network management discovery process (e.g., centralized or distributed), or may rely on manual discovery/provision of network computing resource configuration information to network topology discovery system 420. Here, it should be noted that the network topology information can include network computing device connectivity information, network computing device processing capabilities, and network performance information (e.g., link speeds, latency, energy efficiency, etc.).

The accumulation of such network topology information that is acquired by network topology discovery module 420 provides a resource for consideration by scheduler 410. Scheduler 410 is generally designed to schedule the processing of jobs amongst a selected set of network computing resources 430. As part of this process, scheduler 410 can select a particular set of network computing resources 430 based on network topology information that is provided to scheduler 410 by network topology discovery system 420.

The particular set of network computing resources 430 can be chosen based on particular objectives that may or may not be related to the particular demands of the dataset processing itself. For example, energy efficiency may represent a general policy objective that could override the processing considerations. In one scenario, scheduler 410 can select a set of network computing resources that can maximize the power savings without regard to the time that it takes to complete processing of the dataset. In general, it is recognized that the network performance information included in the network topology information enables scheduler 410 to make tradeoffs between processing and network performance. These tradeoffs enable scheduler 410 to recognize that the network is dynamic, not static with respect to scheduling considerations.

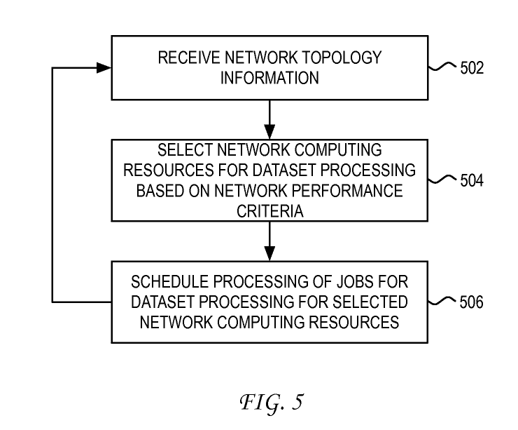

Having described a distributed processing framework that can be based on a dynamic aspect of the network, reference is now made to FIG. 5, which illustrates a flowchart of an example process of the present invention. As illustrated, the process begins at step 502 where network topology information is received. As described above, the network topology information is not confined to traditional computer performance metrics such as Whetstones, MIPS, MegaFLOPS, GigaLIPS, etc., which typically focus on CPU speed. Rather, the network topology information also includes metrics that relate to the dynamic nature of the network (e.g., network link speed, network latency, energy efficiency, etc.).

In one embodiment, the network topology information is collected by a network topology discovery system, which can be centralized or distributed in nature. The network topology information that is collected by the network topology discovery system can then be made available to the scheduler. In one embodiment, the network topology information is stored in a database that is accessible by the scheduler. In other embodiments, the network topology information is transmitted to the scheduler for use in configuring the dataset processing. Here, it should be noted that while a scheduler and a network topology discovery system can be separate systems, such a distinction is not required. The functionality of scheduling and network topology discovery can be performed by a single system.

The availability of network topology information enables the scheduler to analyze the suitability of network computing resources for use in processing a particular dataset. At step 504, the scheduler selects from the network computing resources based on network performance criteria contained in the network topology information. For example, the scheduler can select a particular network computing resource based on network link speed, network latency, energy efficiency, etc. This, of course, being in addition to potential considerations of processing performance of the network computing resources.

The selection of network computing resources from the list of available network computing resources enables the scheduler to tailor the dataset processing to particular needs and/or objectives. Once selected, the scheduler can then schedule the jobs for the dataset processing at step 506. In one embodiment, the scheduling of the jobs for the dataset processing can be designed to leverage the network performance characteristics of the selected set of network computing resources. For example, where an energy efficiency objective was used, the scheduler can schedule jobs in consideration of the energy saving states utilized by the selected network computing resources. In one scenario, the scheduler can schedule jobs that are designed for processing during hours of the day when a network computing resource is not scheduled to be in an energy saving state (e.g., weekends, after work hours, etc.). In another scenario, the scheduler can batch multiple jobs together for delivery to a network computing resource such that the network computing resource can maximize the amount of time that it can leverage an energy saving state. For example, the level of batching that can be used may depend on the energy efficiency/latency tradeoff present. In one scenario, if there are longer wake up times this would allow higher energy savings and better energy efficiency utilization if the jobs are more highly coalesced/batched. As would be appreciated, the particular scheduling considerations used for a particular dataset would be dependent on the network performance parameters used.

As illustrated in the flowchart of FIG. 5, after the scheduling of at step 506, the process can loop back to receive network topology information at step 502. This loopback illustrates an example of re-adjustment/re-balancing based on updates to the network topology information. In fact, in one example, steps 504 and 506 can proceed with little to no network topology information, such that after a first set of job are scheduled, the process can re-adjust/re-balance the processing based on up-to-date network topology information.

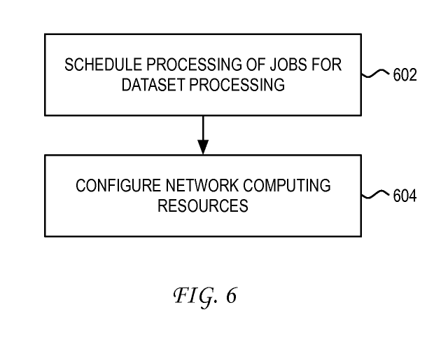

FIG. 6 illustrates a flowchart of another example process of the present invention. As illustrated, the process begins at step 604 where the scheduler schedules the jobs for the dataset processing. In one embodiment, the scheduling can be based on network computing resources that are selected based on network topology information.

After the scheduling of the jobs has been performed, can then configure at step 604 the network computing resources that are to receive the scheduled jobs for processing. In one embodiment, the configuration of the network computing resources is based on network topology information.

In general, the configuration of the network computing resources can be designed to facilitate the processing of the scheduled jobs. In the application to network computing resources that have energy efficiency capabilities, the configuration of the network computing resources can include the configuration of the energy efficiency capabilities to facilitate the processing of the scheduled jobs. In one example, the configuration can include the altering or adjustment of energy efficiency control policies to accommodate the processing of the scheduled jobs Such alterations or adjustments can include allowances or constraints on energy efficiency operation as a whole, allowances or constraints on wake-up times, allowances or constraints on energy saving states that can be used, allowances or constraints on latency, allowances or constraints on link rates, etc.

As would be appreciated, the particular type and extent of the configuration of the network computing resources would be implementation dependent. In general, it is significant that the configuration is in response to the scheduling of jobs for dataset processing on one or more network computing resources.

In one embodiment, a hardware or software module can be used in between the control policy programming of a particular network computing resource and the schedule. For example, there could be a virtual machine manager followed by an API in the software that abstracts the actual programming of the wake-up times for a network computing resource (e.g., the API may only expose aggressive energy mode vs. performance mode). The virtual machine manager could then translate the requirements to the network computing resources present.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method for dataset processing, comprising:
receiving network topology information for a plurality of network computing resources, said network topology information including energy efficiency information;
selecting one of said plurality of network computing resources for assignment to a request for processing a dataset, said selection of said one of said plurality of network computing resources being based on an energy saving state supported by said selected one of said plurality of network computing resources; and
scheduling said processing of said dataset using said selected one of said plurality of network resources.

2. The method of claim 1, wherein said receiving comprises receiving information about one or more energy saving states supported by a network computing resource.

3. The method of claim 1, wherein said receiving comprises receiving link speed information.

4. The method of claim 1, wherein said selecting comprises selecting based on a support of a low power idle mode by said selected one of said plurality of network computing resources.

5. The method of claim 1, wherein said selecting comprises selecting based on a support of a subset physical layer device mode by said selected one of said plurality of network computing resources.

6. The method of claim 1, wherein said selecting comprises selecting based on an energy saving profile of said selected one of said plurality of network computing resources.

7. The method of claim 1, wherein said scheduling comprises batching a plurality of processing jobs associated with said request together for delivery to said selected one of said plurality of network computing resources.

8. A method for dataset processing, comprising:
receiving network topology information for a plurality of network computing resources, said network topology information including energy efficiency information;
selecting one of said plurality of network computing resources for assignment to a request for processing a dataset, said selection of said one of said plurality of network computing resources being based on an energy saving state supported by said selected one of said plurality of network computing resources;
generating a plurality of jobs associated with processing said dataset; and
transmitting said plurality of jobs to said selected one of said plurality of network resources in a time schedule that lowers a utilization of a network link coupled to said selected one of said plurality of network resources, wherein said lowered utilization of said network link enables said selected one of said plurality of network resources to enter said energy saving state.

9. The method of claim 8, wherein said receiving comprises receiving information about one or more energy saving states supported by a network computing resource.

10. The method of claim 8, wherein said receiving comprises receiving link speed information.

11. The method of claim 8, wherein said selecting comprises selecting based on a support of a low power idle mode by said selected one of said plurality of network computing resources.

12. The method of claim 8, wherein said selecting comprises selecting based on a support of a subset physical layer device mode by said selected one of said plurality of network computing resources.

13. The method of claim 8, wherein said transmitting comprises transmitting said plurality of jobs as part of a batch request to said selected one of said plurality of network computing resources.

14. A method for dataset processing, comprising:
selecting one of a plurality of network computing resources for assignment to a request for processing a dataset, said selection of said one of said plurality of network computing resources being based on a performance of a network that connects said selected one of said plurality of network computing resources;
generating a plurality of jobs associated with processing said dataset; and
scheduling a delivery of said plurality of jobs to said selected one of said plurality of network resources.

15. The method of claim 14, wherein said selecting comprises selecting based on a support of a low power idle mode by said selected one of said plurality of network computing resources.

16. The method of claim 14, wherein said selecting comprises selecting based on a support of a subset physical layer device mode by said selected one of said plurality of network computing resources.

17. The method of claim 14, wherein said scheduling comprises scheduling said plurality of jobs as part of a batch request to said selected one of said plurality of network computing resources.

18. The method of claim 14, wherein said network performance information includes energy saving state information for said selected one of said plurality of network computing resources

19. The method of claim 18, wherein said scheduling comprises scheduling in a time schedule that lowers a utilization of a network link coupled to said selected one of said plurality of network resources, wherein said lowered utilization of said network link increases an amount of time that said selected one of said plurality of network resources can remain in an energy saving state.
